(19) United States
(12) Patent Application Publication
(10) Pub. No.: US 2006/0251845 A1
(43) Pub. Date: Nov. 9, 2006

(54) Advertising inserts and methods of making same

(75) Inventor: Alden R. Miles, Lakeville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/125,013

(22) Filed: May 9, 2005

(51) Int. Cl. B32B 33/00

(52) U.S. Cl. 428/42.3; 428/40.1

(57) ABSTRACT

The present invention pertains to an advertising insert. The insert has a liner, a transparent carrier, and a plurality of repostionable items. The carrier is disposed on the liner via a transparent adhesive. The carrier has a top surface opposite a bottom surface, the bottom surface being coated with the transparent adhesive. The repositionable items are disposed on the top surface of the carrier. Each repositionable item has a backing having a first surface opposite a second surface. The first surface has a repositionable adhesive coated on a portion thereof. Each item is stacked on top of another such that the first surface of one repositionable item contacts the second surface of another repositionable item.

### FIELD OF INVENTION

The present invention relates to advertising inserts suitable for use on print media. In particular, the present invention relates to advertising inserts that include repositionable items to allow for quick and convenient removal and for portability of the insert.

### BACKGROUND

Advertising inserts have been used in magazines, periodicals, and newspapers to convey messages to consumers. The inserts can be a stand-alone flyer as commonly used in newspapers. In magazines that have a support backing, e.g., a bound magazine, the insert can be part of the backing and the reader can tear the insert from the magazine at a perforated edge. Recently, advertising inserts have been attached directly to the print media. For example, some advertisements are facilitated by use of a single repositionable paper note having advertising signature, such as e.g., a coupon for discounting goods, directly attached to newspaper or direct mail. Labels with preprinted text and/or text are commonplace. Typically, a label, fully coated with adhesive on one major surface, is carried on a liner. A user peels away the label and attaches it to a target substrate. For example, a label having a preprinted name and address can be used with an envelope.

Some skilled in the art are looking at ways to improve the use and versatility of advertising inserts for today's consumers.

### SUMMARY

In one aspect, the present invention relates to an advertising insert comprising a liner, a transparent carrier including a transparent adhesive, and a plurality of repositionable items. The transparent carrier is disposed on a liner via the transparent adhesive. The transparent carrier has a top surface opposite a bottom surface, the bottom surface being coated with the transparent adhesive. The plurality of repositionable items is disposed on the top surface of the carrier. Each repositionable item comprises a backing having a first surface opposite a second surface. The first surface has a repositionable adhesive coated on a portion thereof. Each repositionable item is stacked on top of another such that the first surface of one repositionable item contacts the second surface of another repositionable item. In one embodiment, the second surface has a release agent coated on a portion thereof. In one embodiment, the second surface of the repostionable item further includes printed text and/or graphics. As used herein, the term “transparent” generally means having the property of transmitting light without appreciable scattering so that images lying beyond can be seen. In one embodiment, there are no images applied to the transparent carrier and/or the liner. The term “repositionable” generally means having the property of being adhered to and removed from a surface multiple times.

In another aspect, the present invention pertains to a method of making an advertising insert. The method comprises the steps (i) providing a first web of repositionable material, the first web having a first surface opposite a second surface, the first surface having a repositionable adhesive coated on a portion thereof; (ii) providing a second web of repositionable material, the second web having a first surface opposite a second surface, the first surface having a repositionable adhesive coated on a portion thereof; (iii) applying an image to the second side of at least one of the first and second webs; (iv) providing a third web comprising a liner and a transparent carrier attached to the liner via a transparent adhesive; (v) stacking the first web, second web, liner such that the first surface of the first web contacts the second surface of the second web, the first surface of the second web contacts a top surface of the transparent carrier to yield a stacked web; and (vi) cutting the stacked web to a controlled depth to yield discrete advertising inserts disposed on the liner. In one method, a portion of the second surface of the first and/or second web and a portion of the top surface of the carrier contains a release agent. In another method, the image is applied to the first web and the second web in registration. The term “registration” generally means that the images on the first, second, and any subsequent webs are in approximate alignment with each other. This feature can be useful because during the cutting steps, the images can be aligned with the cutting device so that they are substantially within the advertising insert.

One advantage of the present invention is that each advertising insert can include a plurality of repositionable items, each item containing a different advertising signature. In this way, the advertiser can convey different messages to the consumer. If desired, however, the insert can contain the same message, e.g., in the case where the advertiser intended to issue multiple coupons for the same good.

Another advantage of the present invention is that both the carrier and the adhesive used on the carrier are transparent so that they do not obstruct the underlying image upon which they are attached. If desired, the repositionable item may contain color and each repositionable item may be of a different color.

Yet another advantage of the present invention is that because each repositionable item includes a repositionable adhesive on its first or back surface, the consumer is able to attach and reattach the item to a convenient location, e.g., in a wallet or purse or in the car, as a reminder. The advertising insert includes a plurality of repositionable items that do not have to be bounded by one edge, like that of a scratch pad, because each item includes its own repositionable adhesive. The repositionable items do not include a perforation for removal from each other or from the carrier. Instead, the consumer can peel each item away from the other or from the carrier for use.

### BRIEF DESCRIPTION OF THE DRAWINGS

The present invention can be further described with reference to the following drawings, wherein:

FIG. 1 is a cross-sectional view of one exemplary advertising insert of the invention;

FIG. 2 is a cross-sectional view of another exemplary advertising insert of the invention;

FIG. 3 is a perspective view of an exemplary advertising insert of the present invention attached to print media, such as a newspaper;

FIG. 4 is a schematic illustration of an exemplary process of the present invention;

FIG. 5 is a perspective view of the advertising insert of the present invention wound in roll form; and

FIG. 6 is a perspective view of the advertising insert of the present invention stored in fan-fold form.

These figures are idealized, not drawn to scale, and are intended for illustrative purposes only.

### DETAILED DESCRIPTION

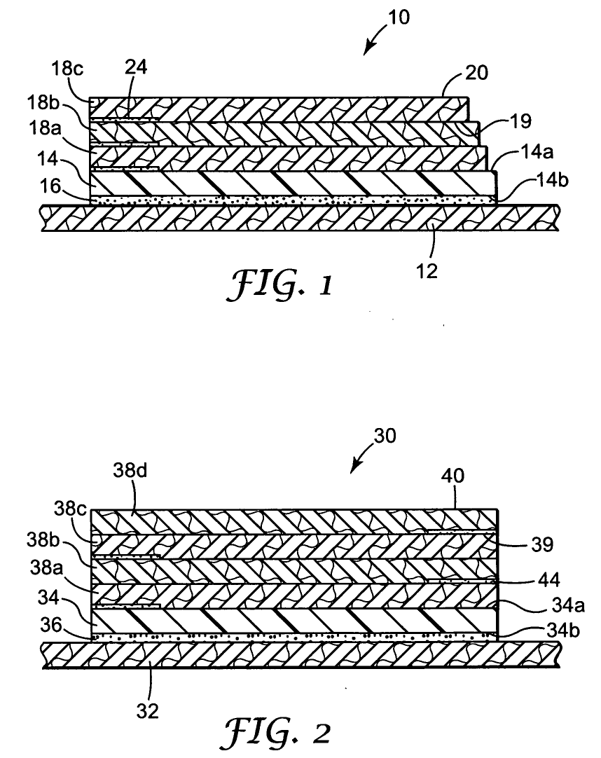

FIG. 1 shows a cross-sectional view of an exemplary advertising insert 10 having a plurality of repositionable items, 18a, 18b, and 18c disposed on transparent carrier 14. Each repositionable item has a first surface upon which a portion is coated with repositionable adhesive 24 and a second surface, opposite the first surface. In one embodiment, a portion of the second surface is coated with a release agent. Taking, for example, repostionable item 18c, the repositionable adhesive is coated on a portion of first surface 19 and the release agent, if used, is coated on second surface 20. The release agent is applied in the same general location as the repositionable adhesive, although on the second side of the repositionable item, so that upon stacking of the items, the repositionable adhesive is in contact with the release agent. It is within the scope of the present invention to have the second surface of the repositionable item fully or substantially fully coated with the release agent. The repositionable items are stacked such that repositionable adhesive 24 on each item is disposed on the same end of the stack of items. Transparent carrier 14 has top surface 14a, upon which the repositionable items are stacked, and bottom surface 14b, where transparent adhesive 16 is coated. In one embodiment, like the repostionable items, at least a portion of the top surface of the transparent carrier may be coated with a release agent. In another embodiment, the advertising insert includes a coating that functions as a release agent on the carrier as well as a primer for the repositionable adhesive on the repositionable item. In yet another embodiment, the advertising insert includes a first coating functioning as a release agent and a second coating functioning as the primer. The selection of the appropriate primer and release agent depends on the selection of the repositionable adhesive. The carrier is disposed on liner 12 such that transparent adhesive 16 contacts the liner. As shown, the repositionable items are indexed with respect to one another to facilitate removal of the repostionable items. While step indexing is shown, i.e., item 18a is longer than item 18b, which is longer than item 18c, thereby creating a step-like appearance, any number of different indexing orders can be used.

FIG. 2 shows a cross-sectional view of another exemplary advertising insert 30 having a plurality of repositionable items, 38a, 38b, 38c, and 38d disposed on transparent carrier 34. Each repositionable item includes repositionable adhesive 44 disposed on at least a portion of a first side of the item. Taking, e.g., repostionable item 38d, the repositionable adhesive is coated on a portion of first surface 39 and, if desired, an optional release agent (not shown) may be coated on second surface 40. The repositionable items are stacked so that repositionable adhesive 44 is disposed on different ends of the item. In this particular case, the repositionable adhesive is stacked on opposing ends of the items on alternating items to create a “z-stacked” system. While the repositionable items in this embodiment are not indexed, they can be indexed if desired. The repositionable items are stacked on first surface 34a of transparent carrier 34. Transparent adhesive 36 is coated on second surface 34b of the carrier allowing the carrier to be attached to liner 32. In one embodiment, the transparent carrier or the transparent adhesive contains color.

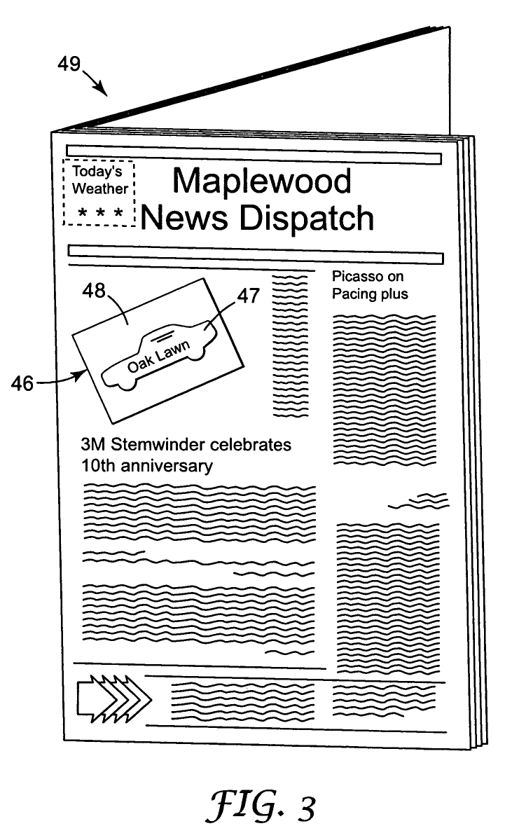

FIG. 3 shows a perspective view of the advertising insert 46 attached to print media, in this case, newspaper 49. The insert includes first repositionable item 47 in the shape of an automobile and second, rectangular shaped repositionable item 48. Thus, the advertising insert of the present invention can include items that are non-polygonal in shape and each item may be of a different shape.

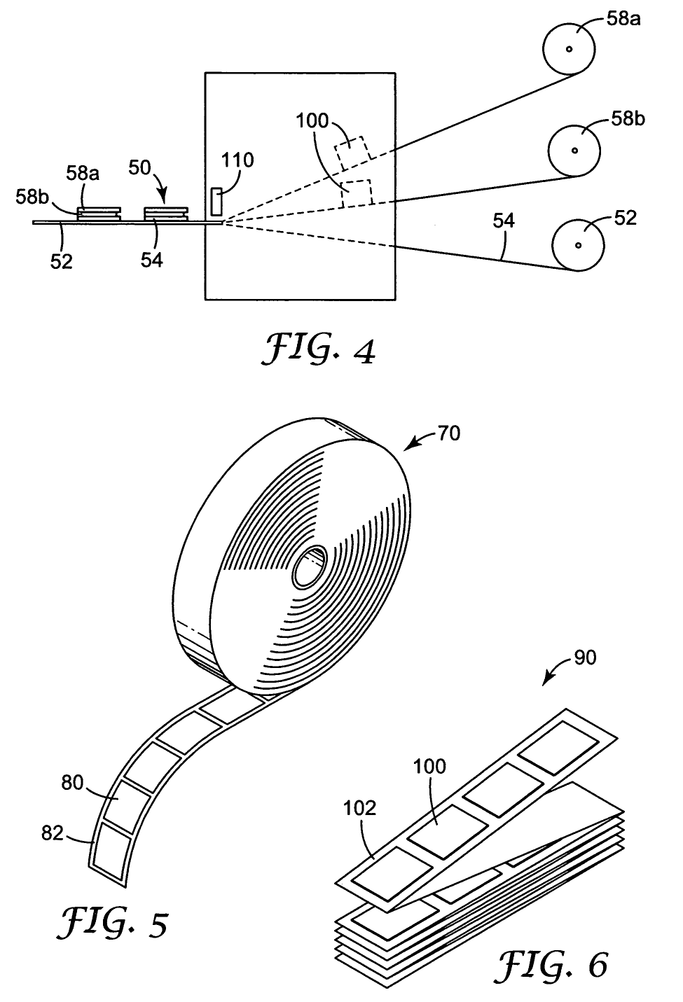

FIG. 4 is a schematic diagram of an exemplary method of the present invention. The method includes the steps of providing first and second webs of repositionable materials 58a and 58b respectively. Each web has a first surface opposite a second surface. The first surface has a repostionable adhesive coated on a portion thereof. The second surface optionally includes a release agent coated on a portion thereof, again, typically in the same general location, but on the second side, where the repositionable adhesive is coated. In one embodiment, the repositionable adhesive is a pressure sensitive adhesive. Transparent carrier 54 is attached to liner 52 via a transparent adhesive (not shown). The transparent adhesive may be a repositionable adhesive or a permanent adhesive. As used herein, the term “permanent” generally means having the property that the adhesive is not readily removable from the substrate without damage to the substrate or the adhesive. The first web, second web, and the liner are all provided in substantially continuous web, e.g., in a roll form. They are directed into a processing unit where images are applied to first web 58a and second web 58b at station 100. In one method, the image is applied to the webs in registration. The image may be applied to the second surface of the repositionable item before or after the release coating is applied, if a release coating is used so long as one repositionable item can be released from the next item. The image and release coating should be compatible with each other, meaning that the images should not be smeared during or after they have been applied to the repositionable item. At station 110, all webs are stacked on top of one another such that the first surface of first web 58a contacts the second surface of second web 58b, and the first surface of second web 58b contacts the top surface of the transparent carrier. In one method, the first and second webs are stacked in registration so that the images are aligned. At station 110, the first and second webs and the transparent carrier are cut to yield a discrete advertising insert 50. The insert includes a first repositionable item 58a and a second repositionable item 58b disposed on transparent carrier 54 carried by liner 52 via a transparent adhesive (not shown). If desired, any excess first web, second web, and transparent carrier not part of the advertising insert is removed. The cutting action occurring at station 110 is to a controlled depth such that the liner is not cut. In FIG. 5, insert 80 on liner 82 is wound into roll 70 for convenient packaging and shipment. In FIG. 6, insert 90 on liner 102 is packaged in fanfold-form.

The repositionable items that are useful in the practice of the present invention include paper or plastic notes, paper or plastic flags, and labels. In general, a note typically has a stripe of repositionable adhesive coated on a portion of its first surface; a flag typically has a large portion, e.g., half of the surface area of the first surface, coated with an adhesive; and a label typically has the entire surface area of its first surface coated with the adhesive. Any size of repositionable item can be used to communicate the message to the consumer. Typically notes are larger in dimensions than flags.

Useful adhesives that can be used for the repositionable adhesives are disclosed in U.S. Pat. Nos. 3,691,140; 3,922,464; 5,663,241; 5,714,237; 5,824,748; and 6,017,624. Useful coatings to be used as release agents and/or primers are disclosed in U.S. Pat. Nos. 5,032,460 and 5,202,190. U.S. Pat. No. 4,907,825 describes useful flags that may be used in the present invention. The patents listed in this paragraph are all incorporated by reference.

While the focus thus far has been directed to the use of a transparent carrier and a transparent adhesive, in one embodiment, either or both of those components may be opaque. This particular construction may be useful for direct mail applications, for attachment to the outside of envelopes where there may be no underlying images or where the obstruction of the underlying image is not a concern. In such a case, it may be desirable to have images on the carrier.

What is claimed is:

1. An advertising insert comprising:
a liner;
a transparent carrier disposed on a liner via a transparent adhesive, the carrier having a top surface opposite a bottom surface, the bottom surface being coated with the adhesive; and
a plurality of repositionable items disposed on the top surface of the carrier, wherein each repositionable item comprises a backing having a first surface opposite a second surface, the first surface having a repositionable adhesive coated on a portion thereof, each repositionable item stacked on top of another such that the first surface of one repositionable item contacts the second surface of another repositionable item.

2. The advertising insert of claim 1, wherein a release agent is disposed a portion of the second surface of the repositionable item.

3. The advertising insert of claim 1, wherein the second surface of the repositionable item comprises an image.

4. The advertising insert of claim 1, wherein the liner has been removed and the advertising insert is attached to print media such that the transparent adhesive is in contact with the print media.

5. The advertising insert of claim 4, wherein the adhesion of the transparent adhesive to the print media is greater than the adhesion between the repositionable items.

6. The advertising insert of claim 4, wherein the print media is selected from the group consisting of newspaper, magazines, catalogs, and direct mail.

7. The advertising insert of claim 1 wherein each repositionable item is stacked such that the repositionable adhesive is disposed on the same end of the repositionable item.

8. The advertising insert of claim 1, wherein the repositionable items are stacked such that the repositionable adhesive is disposed on opposite ends of the repositionable item on alternating items.

9. The advertising insert of claim 1 wherein each repositionable item is indexed with respect to the next adjacent repositionable item.

10. The advertising insert of claim 1, wherein each repositionable item is of a different color.

11. The advertising insert of claim 1, wherein the transparent adhesive is a repositionable pressure sensitive adhesive or a permanent adhesive.

12. The advertising insert of claim 1, wherein the repositionable items are non-polygonal in shape.

13. The advertising insert of claim 1, wherein the repositionable items are of different shapes.

14. The advertising insert of claim 1, wherein the transparent carrier or the transparent adhesive contains color.

15. A method of making an advertising insert comprising the steps of:
providing a first web of repositionable material, the first web having a first surface opposite a second surface, the first surface having a repositionable adhesive coated on a portion thereof;
providing a second web of repositionable material, the second web having a first surface opposite a second surface, the first surface having a repositionable adhesive coated on a portion thereof;
applying an image to the second side of at least one of the first and second webs;
providing a third web comprising a liner and a transparent carrier attached to the liner via a transparent adhesive;
stacking the first web, second web, and third web such that the first surface of the first web contacts the second surface of the second web, the first surface of the second web contacts a top surface of the transparent carrier to yield a stacked web; and
cutting the stacked web to a controlled depth to yield discrete advertising inserts disposed on the liner.

16. The method of claim 15 further comprising providing at least another web of repositionable material.

17. The method of claim 15 wherein the discrete inserts disposed on the liner is wound into roll form or in fanfold-form.

18. The method of claim 15, wherein the second surface of the first web, the second surface of the second web, or the top surface of the transparent carrier comprises a release agent.

19. The method of claim 15, wherein the image is applied to the first web and the second web in registration.

20. The method of claim 15, wherein the transparent carrier or the transparent adhesive contains color.
